(19) United States
(12) Patent Application Publication
(10) Pub. No.: US 2023/0146461 A1
(43) Pub. Date: May 11, 2023

(54) A STACK OF HISTOLOGY CASSETTES

(71) Applicant: SHANDON DIAGNOSTICS LIMITED, Runcorn Cheshire (GB)

(72) Inventors: Molly HARRIS, Cheshire (GB); Karolina BIGAJ, Cheshire (GB); Kathryn NORRIS, Cheshire (GB)

(21) Appl. No.: 17/906,669

(22) PCT Filed: Feb. 9, 2021
(86) PCT No.: PCT/EP2021/053109

§ 371 Date: Sep. 19, 2022

(30) Foreign Application Priority Data
Mar. 27, 2020 (GB) 2004476.4

(51) Int. Cl. B01L 9/00; B65D 21/02; B65D 85/62

(52) U.S. Cl. CPC B01L 9/52; B65D 21/02; B65D 85/62; B01L 2200/025; B01L 2300/0812; B01L 2300/0822

(57) ABSTRACT

A stack of histology cassettes configured to be inserted into a hopper of a printer, wherein each histology cassette in the stack includes a bottom face, a top face opposite the bottom face, a front face, a rear face opposite the front face, a first lateral face and a second lateral face opposite the first lateral face. The top face of the histology cassette is open to allow a sample to be received within the histology cassette. The histology cassettes have substantially the same orientation within the stack. The histology cassettes in the stack are arranged with a first histology cassette at the bottom of a stack, and each subsequent histology cassette in the stack up to a last histology cassette in the stack is arranged with its bottom face positioned on the top face of a preceding histology cassette in the stack.

### FIELD OF THE INVENTION

The present invention relates to a stack of histology cassettes configured to be inserted into a hopper of a printer.

### BACKGROUND

When biological tissue samples are collected, it is common to prepare the samples for analysis, e.g. for viewing under a microscope. One method of preparation is to process the tissue samples by treating the biological tissue using various fluids and then to embed each sample in an embedding medium, typically a block of paraffin wax. The various fluids used to treat the samples are typically referred to as reagents and may include: fixatives, alcohols and clearing agents (e.g. hydrocarbon solvents such as xylene).

Biological tissue samples are typically processed by a tissue processing apparatus, which may be an enclosed tissue processor for anatomical pathology. Prior to processing biological tissue in a tissue processing apparatus, the biological tissue is typically stored in a fixative such as Formaldehyde. Within a typical tissue processing apparatus, a biological tissue sample is first treated with alcohol, and then with a clearing agent (typically a hydrocarbon solvent, such as xylene). Finally, the tissue processing apparatus treats the biological tissue with paraffin wax (an embedding medium) so as to infiltrate and fill the biological tissue with the wax. It typically takes 14 hours for the tissue processing apparatus to complete this process.

Next, the biological tissue is embedded in a block of paraffin wax by a tissue embedding apparatus, which may be referred to as an “embedding centre”, in which the biological tissue (now filled with wax) is placed in a mould then filled with paraffin wax, which is rapidly cooled to form a solidified block of paraffin wax of predetermined shape and size (determined by the mould) containing the biological tissue. The predetermined shape and size of the block is chosen so that the solidified block is of a suitable shape and size to be used in a microtome, where the biological tissue can be cut into very fine slices that are suitable for use under a microscope.

Histology cassettes, often referred to simply as “cassettes”, are used to hold biological tissue samples during processing and embedding of the samples.

Histology cassettes are typically marked with data for use in identifying and tracking a sample held by the cassette whilst the cassette is in use. Such data is referred to as “cassette data” herein. The cassette data may include a visual machine-readable identifier such as a barcode (e.g. a 1D or 2D barcode). The cassette data may include a patient name which identifies a patient who provided a sample held by the cassette. The cassette data may include a string of letters and/or numbers which uniquely identifies the sample. The cassette data may include details of the lab which obtained the sample.

In most modern devices, histology cassettes are marked with cassette data by a printer, which may be referred to as a histology cassette printer, but is herein referred to simply as a “printer”.

A typical printer includes a hopper configured to hold a stack of histology cassettes, wherein the printer is configured to print data onto each cassette held by the hopper, e.g. based on a signal from a computer.

Typically, a hopper will hold 30 or more cassettes, e.g. 60-80 cassettes. Typically cassette data is printed by the printer directly onto a material from which the cassette itself is made. But it is also possible for a printer to print cassette data onto a label applied to the cassette. For practical reasons, cassette data is usually printed onto a cassette before holding a sample in the cassette.

Histology cassettes can be supplied in a number of different packaging arrangements to feed into a printer. The packaging arrangement is usually dependent on the printer used. In some cases, histology cassettes are hand fed into a printer loose, i.e. one at a time. However, this is burdensome and can lead to cassettes becoming stuck in a hopper of the printer. In other cases, a stack of histology cassettes are loaded together into (e.g. a hopper of) a printer.

It is known for a stack of histology cassettes to be taped together, primarily to facilitate easier loading the cassettes into a printer.

For example, EP1238706A2 and U.S. Pat. No. 7,507,379B2 disclose arrangements in which an adhesive tape adheres to one side of a stack of histology cassettes. The present inventors have observed that a stack of histology cassettes bound together in this way is unstable (e.g. floppy) and difficult to insert into a hopper of a printer (particularly one handed).

US 2015/0241325A1 and EP2881175A1 disclose arrangements in which a stack of histology cassettes are held together by a non-adhesive strip which passes through an aperture in each of the histology cassettes. The present inventors have observed that a stack of histology cassettes bound together in this way can still be a slightly unstable (e.g. floppy) and difficult to insert into a hopper of a printer (particularly one handed). Moreover, the present inventors have observed that disconnecting the histology cassettes by pulling out the non-adhesive strip from the cassettes requires considerable force, which might be challenging for some users. Moreover, these arrangements only work with histology cassettes which include a suitable aperture through which the non-adhesive strip can be inserted—such apertures are not present in many histology cassettes.

The present invention has been devised in light of the above considerations.

### SUMMARY OF THE INVENTION

A first aspect of the invention provides:
A stack of histology cassettes configured to be inserted into a hopper of a printer;
wherein each histology cassette in the stack includes a bottom face, a top face opposite the bottom face, a front face, a rear face opposite the front face, a first lateral face and a second lateral face opposite the first lateral face, wherein the top face of the histology cassette is open to allow a sample to be received within the histology cassette;
wherein the histology cassettes have substantially the same orientation within the stack;
wherein the histology cassettes in the stack are arranged with a first histology cassette at the bottom of a stack, and with each subsequent histology cassette in the stack up to a last histology cassette in the stack being arranged with its bottom face being positioned on the top face of a preceding histology cassette in the stack;
wherein the histology cassettes in the stack are held together by a length of tape which loops around the entire stack of histology cassettes;
wherein the length of tape includes a first fixing region and a second fixing region wherein the first fixing region overlaps and adheres to the second fixing region;
wherein the length of tape includes a release region at an end of the length of tape, the release region being configured to be pulled by a user after the stack of histology cassettes has been inserted into a hopper of a printer so as to release the first fixing region from the second fixing region thereby releasing the histology cassettes within the hopper of the printer.

By looping the tape around the entire stack of histology cassettes, the cassettes in the stack can be tightly held together in a more stable fashion and thus easily manipulated with one hand. Yet the cassettes can be easily released from being held together after being inserted into the printer simply by pulling on the release region. The release region may herein be referred to as a release tab.

Preferably, the release region is at a first end of the length of tape, wherein the first fixing region is closer to the first end of the length of tape than to a second end of the length of tape opposite to the first end of the length of tape. Preferably, the release region and the first fixing region are on the same side of the stack as each other.

These features help to facilitate easy release of the first fixing region from the second fixing region by pulling on the release region.

The second fixing region may be closer to the second end of the length of tape than the first end of the length of tape. But this is not a requirement, since the length of tape could loop around the entire stack of histology cassettes, such that the first and second fixing regions are both closer to the first end of the length of tape.

Preferably, the length of tape holds the histology cassettes together, preferably rigidly together, by applying pressure to the histology cassettes (e.g. by tightly wrapping around the stack of histology cassettes), more preferably without the length of tape adhering to the histology cassettes. These features help to facilitate the releasing of the cassettes in the printer, without leaving a deposit of sticky material (e.g. a sticky film of glue) on the cassettes.

In some examples, the length of tape is configured so that the release region projects outwardly from the stack of histology cassettes. This may be achieved, for example, by bending the length of tape so that the release region projects outwardly from the stack of histology cassettes. This may help a user locate the release region, prior to pulling on it.

A length axis may be defined with respect to each histology cassette as extending from the rear face to the front face of the cassette. A lateral axis may be defined with respect to each histology cassette as extending from the first lateral face to the second lateral face of the cassette. A depth axis may be defined with respect to each histology cassette as extending from the bottom face to the top face of the cassette. The length, lateral and depth axes are preferably mutually orthogonal.

The cassette is preferably longer in the direction of the length axis of the cassette than it is wide in the direction of the lateral axis of the cassette. The cassette is preferably wider in the direction of the lateral axis of the cassette than it is deep in the depth direction of the cassette.

The stack may have a front face formed by the front faces of the cassettes in the stack, a rear face formed by the rear faces of the cassettes in the stack, a first lateral face formed by the first lateral faces of the cassettes in the stack, a second lateral face formed by the second lateral faces of the cassettes in the stack, a bottom face formed by the bottom face of the first cassette in the stack, and a top face formed by the top face of the last cassette in the stack.

The length of tape looped around the entire stack of histology cassettes preferably extends along the top face, first lateral face, bottom face and second lateral face of the stack. This is preferable to the length of tape looping around the stack in other configurations since it helps to facilitate easy insertion into a hopper of a printer. For example, looping the tape around the stack in this configuration allows for use of a tape that is wider, compared with a configuration in which the tape extends along the top, front, bottom and rear faces of the stack (where the cassettes in the stack are longer in the direction of the length axis of the cassette than they are wide in the direction of the lateral axis of the cassette—see above).

However, in other embodiments, it would be possible for the tape to instead extend along the top, front, bottom and rear faces of the stack.

Embodiments in which the tape extends along the front, first lateral, rear and second lateral faces of the stack may also be possible, depending on the shape of the cassettes, and configuration of the printer.

A second aspect of the invention may provide a histology cassette system including:
a stack of histology cassettes according to the first aspect of the invention;
a printer including a hopper configured to receive the stack of histology cassettes.

The hopper can be considered as any element configured to receive a stack of histology cassettes, and may have a tubular form. The hopper may be integral with, or detachable from the printer. The hopper may alternatively be referred to as a “magazine”, and the terms “hopper” and “magazine” may be used interchangeably herein. The hopper may hold 30 or more cassettes.

The printer may be configured to print data onto each cassette held by the hopper, e.g. based on a signal from a computer. The printer may be configured to sequentially print data onto each cassette (i.e. print on each cassette in turn), starting with the first cassette.

The printer may be configured to print cassette data onto each cassette by printing directly onto a material from which the cassette itself is made. But it is also possible for the printer to be configured to print cassette data onto each cassette by printing onto a label applied to the cassette. For practical reasons, the printer may be configured to print cassette data onto each cassette before holding a sample in the cassette.

The hopper may include a front wall, rear wall, first lateral wall and second lateral wall which define a passage configured to receive the stack of histology cassettes such that when the stack of histology cassettes is inserted into the hopper, the front wall of the stack faces the front wall of the hopper, the rear wall of the stack faces the rear wall of the hopper, the first lateral wall of the stack faces the first lateral wall of the hopper and the second lateral wall of the stack faces the second lateral wall of the hopper.

The printer may be configured to receive the stack of histology cassettes with the bottom face of the stack of histology cassettes being inserted first into the passage defined by the front, rear, first lateral and second lateral walls of the hopper. Other hopper arrangements are possible.

One of the walls of the hopper (i.e. one of the front wall, rear wall, first lateral wall and second lateral wall), preferably one of the lateral walls of the hopper (i.e. the first or second lateral wall), may include a slot extending in the direction of the passage defined by the walls, to allow manipulation of the cassettes within the hopper.

The tape which loops around the entire stack of cassettes may be configured such that the release region of the tape is accessible via the slot (e.g. by the tape being aligned with this slot such that a user can reach the release region with their fingers via the slot) when the stack of cassettes has been inserted into the hopper, so as to facilitate easy separation of the cassettes within the hopper, i.e. such that the release tab can be pulled by a user after the stack of cassettes has been inserted into the hopper.

The tape which loops around the entire stack of cassettes may be configured such that the release region of the tape is visible via the slot (e.g. by being aligned with this slot such that a user can see the release region) when the stack of cassettes has been inserted into the hopper, again so as to facilitate easy separation of the cassettes within the hopper.

The release tab may also be configured to align with this slot, when the stack of cassettes has been inserted into the hopper, so as to facilitate easy separation of the cassettes within the hopper, i.e. such that the release tab can be pulled by a user after the stack of cassettes has been inserted into the hopper.

The invention includes the combination of the aspects and preferred features described except where such a combination is clearly impermissible or expressly avoided.

### SUMMARY OF THE FIGURES

Examples illustrating the principles of the invention will now be discussed with reference to the accompanying figures in which:

FIG. 1 is a perspective view of a histology cassette.

FIG. 2 is a perspective view of a stack of histology cassettes.

FIG. 3 is a perspective view of a hopper configured to receive a stack of histology cassettes.

FIGS. 4(a)-(e) show steps in the removal of a length of tape from around a stack of histology cassettes.

FIG. 5 is a perspective view of a further example of a stack of histology cassettes.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

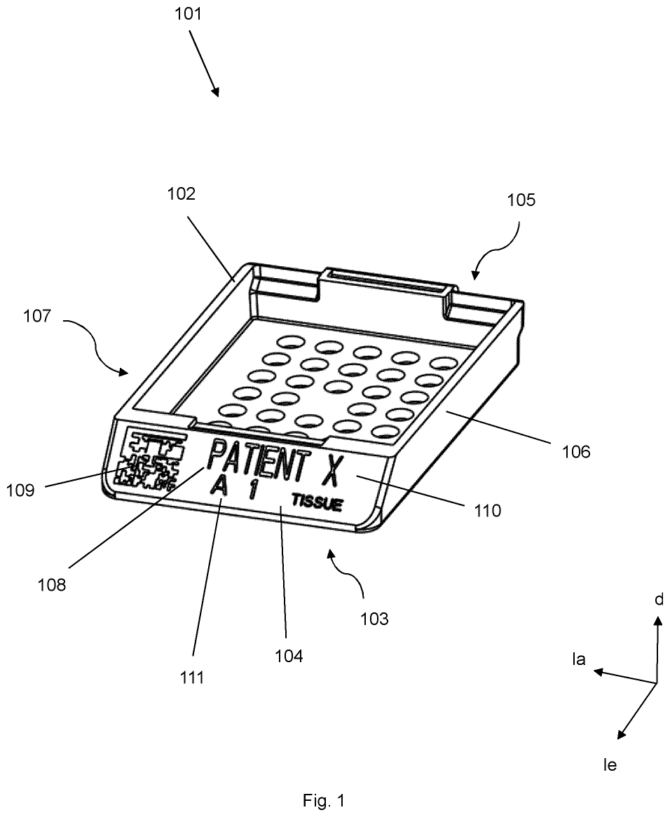

FIG. 1 is a perspective view of a histology cassette 101 with histology cassette data 108 printed on the histology cassette 101.

The histology cassette 101 as shown in FIG. 1 includes a top face 102, a bottom face 103 opposite the top face 102, a front face 104, a rear face 105 opposite the front face 104, a first lateral face 106 and a second lateral face 107 opposite the first lateral face 106. The top face 102 of the histology cassette 101 is open.

On the front face 104 of the histology cassette 101 is cassette data 108. The cassette data 108 includes a visual machine-readable identifier 109, a patient name 110 (in this case “patient X”) and a string of letters and numbers 111 (in this case “A1”).

A length axis “le” may be defined with respect to the histology cassette 101 as extending from the rear face 105 to the front face 104 of the histology cassette 101. A lateral axis “la” may be defined with respect to the histology cassette 101 as extending from the first lateral face 106 to the second lateral face 107 of the histology cassette 101. A depth axis “d” may be defined with respect to the histology cassette 101 as extending from the bottom face 103 to the top face 102 of the histology cassette 101. The length, lateral and depth axes are mutually orthogonal.

The histology cassette 101 as shown in FIG. 1 is longer in the direction of the length axis of the histology cassette 101 than it is wide in the direction of the lateral axis of the histology cassette 101. The histology cassette 101 is wider in the direction of the lateral axis of the histology cassette 101 than it is deep in the depth direction of the histology cassette 101.

In use, the top face 102 of the histology cassette 101 is open to allow a biological tissue sample (which may be referred to as a “sample” herein) to be received within the histology cassette 101. The histology cassette 101 then holds the sample during the processing and embedding of the sample.

The histology cassette data 108 identifies and tracks a sample held by the histology cassette 101 whilst the histology cassette 101 is in use. The patient name 110 identifies a patient who provided a sample held by the histology cassette 101. The string of letters and numbers 111 in the cassette data 108 uniquely identify the sample.

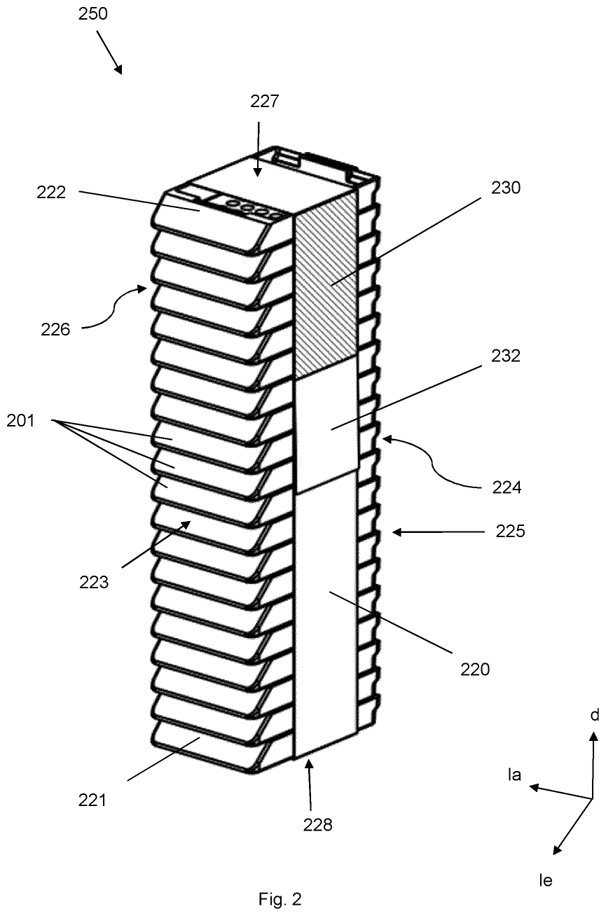

FIG. 2 shows a stack 250 of histology cassettes 201 according to an example of the present invention.

Each histology cassette 201 in the stack 250 may have the same configuration as the histology cassette 101 shown in FIG. 1 prior to the printing of cassette data 108 by a printer onto the front face 104 of each histology cassette 201 in the stack 250 of histology cassettes 201. The stack 250 of histology cassettes 201 shown in FIG. 2 has a length of tape 220 looped around the entire stack 250 of histology cassettes 201.

Each histology cassette 201 in the stack 250 has substantially the same orientation within the stack 250. The histology cassettes 201 in the stack 250 are arranged with a first histology cassette 221 at the bottom of a stack 250. Each subsequent histology cassette in the stack 250, up to a last histology cassette 222 in the stack 250, is arranged with its bottom face positioned on the top face of a preceding histology cassette in the stack 250.

As discussed in relation to the histology cassette 101 shown to FIG. 1, a length axis “le” may be defined as extending from the rear face to the front face of each histology cassette 201. A lateral axis “la” may be defined as extending from the first lateral face to the second lateral face of each histology cassette 201. A depth axis “d” may be defined as extending from the bottom face to the top face of each histology cassette 201. The length, lateral and depth axes are mutually orthogonal.

Each histology cassette 201 in the stack 250 is longer in the direction of the length axis than it is wide in the direction of the lateral axis. Each histology cassette 201 in the stack 250 is wider in the direction of the lateral than it is deep in the depth direction.

The stack 250 of histology cassettes 201 has a front face 223, a rear face 224, a first lateral face 225, a second lateral face 226, a top face 227 and a bottom face 228. The front face 223 is formed by the front faces of the histology cassettes 201 in the stack 250. The rear face 224 is formed by the rear faces of the histology cassettes 201 in the stack 250. The first lateral face 225 is formed by the first lateral faces of the histology cassettes 201 in the stack 250. The second lateral face 226 is formed by the second lateral faces of the histology cassettes 201 in the stack 250. The top face 227 is formed by the top face 227 of the last histology cassette 222 in the stack 250. The bottom face 228 is formed by the bottom face of the first histology cassette 221 in the stack 250.

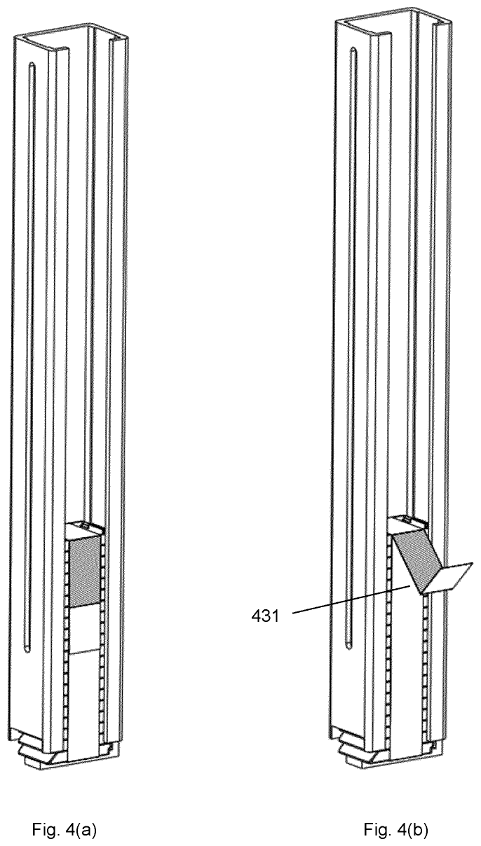

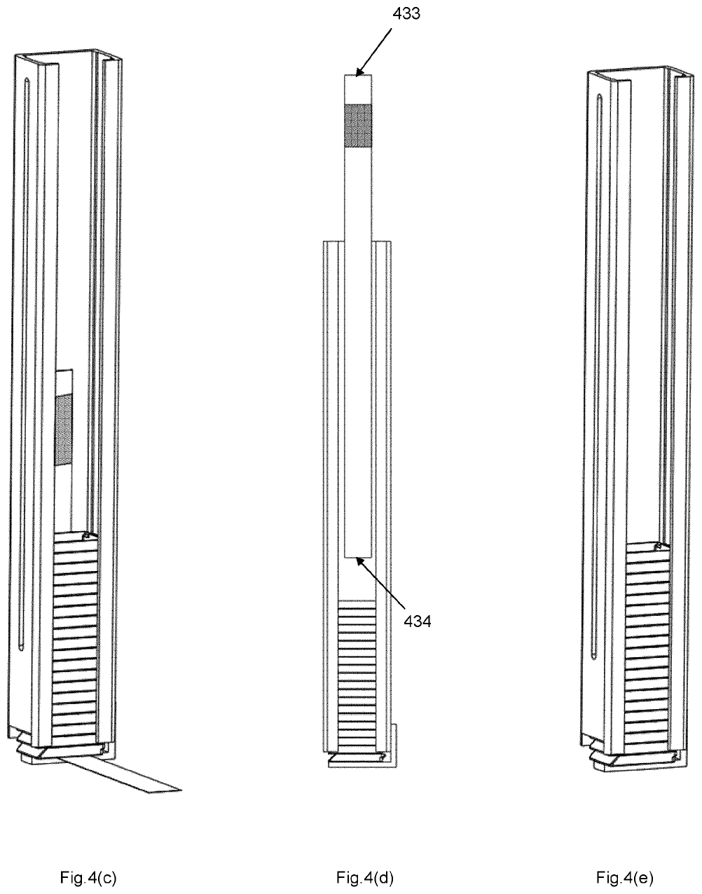

The length of tape 220 has a first end 433 and a second end 434 (shown in later figures). The first end 433 of the length of tape 220 is opposite the second end 434 of the length of tape 220. The length of tape 220 is looped around the entire stack 250 of histology cassettes 201. The loop of tape 220 extends along the top face 227, the first lateral face 225, the bottom face 228 and the second lateral face 226 of the stack 250 of histological cassettes 201. The length of tape 220 includes a first fixing region 230 and a second fixing region 431 (shown in later figures). Only the first fixing region 230 is visible because the second fixing region 431 is underneath the first fixing region 230. The second fixing region 431 can be seen in FIG. 4(b). The first fixing region 230 is closer to the first end 433 of the length of tape 220 than to the second end 434 of the length of tape 220. The first fixing region 230 overlaps and adheres to the second fixing region 431. The length of tape 220 also includes a release region 232. The release region 232 may be referred to as the release tab. The release region 232 is at the first end 433 of the length of tape 220 and the release region 232 and the first fixing region 230 are on the same side of the stack 250 of histology cassettes 201 as each other. The release region 232 is closer to the first end 433 of the length of tape 220 than the first fixing region 230 is to the first end 433 of the length of tape 220.

In this example, the length of tape 220 rigidly holds together the stack 250 histology cassettes 201 by applying pressure to the stack 250 of histology cassettes 201. In this example, this rigid holding together of the histology cassettes 201 is achieved by the length of tape 220 being tightly looped around the stack 250 of histology cassettes 201 without the length of tape 220 adhering to the histology cassettes 201.

The release region 232 is configured to be pulled by the user after the stack 250 of histology cassettes 201 has been inserted into a hopper 375 (shown in later figures) of a histology cassette 201 printer so as to release the first fixing region 230 from the second fixing region 431 thereby releasing the histology cassettes 201 within the hopper 375 of the histology cassette 201 printer.

By rigidly holding the stack 250 of histology cassettes 201 together, the stack 250 of histology cassettes 201 is able to be moved without the histology cassettes 201 flopping around. This allows for a stack 250 of histology cassettes 201 to be inserted into a hopper 375 of a histology cassette 201 printer more easily (especially when only using one hand to insert the histology cassettes 201 into the printer).

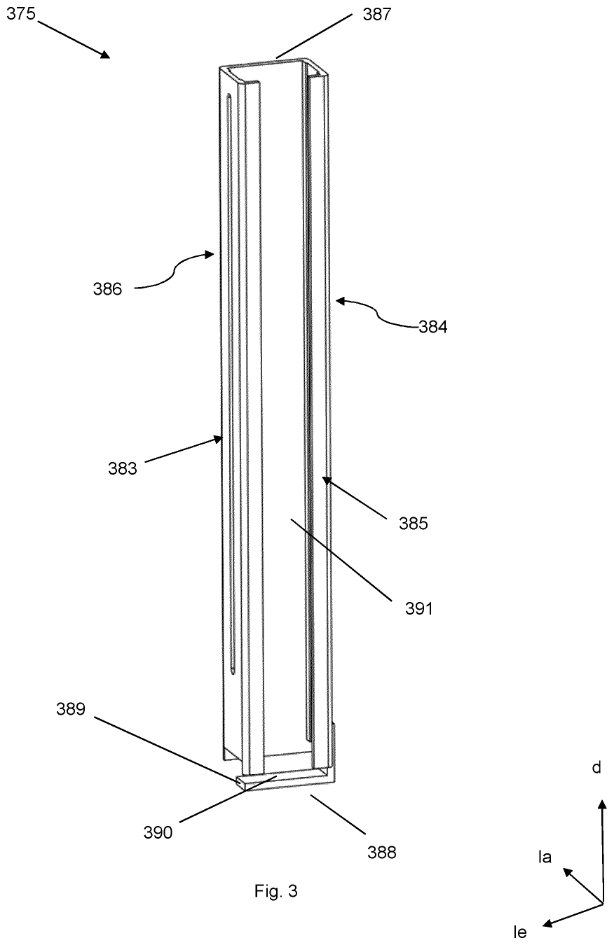

FIG. 3 shows a perspective view of a hopper 375 configured to receive the stack 250 of histology cassettes 201 shown in FIG. 2.

The hopper 375 has a front wall 383, a rear wall 384 opposite the front wall 383, a first lateral wall 385, and a second lateral wall 386 opposite the first lateral wall 385. The front wall 383, the rear wall 384, the first lateral wall 385 and the second lateral wall 386 define a passage. The passage has a first end 387 which is open and a second end 388 opposite the first open end 387. The first lateral wall 385 has a slot 391 extending in the direction of the passage defined by the walls 383, 384, 385, 386. The slot 391 extends from the first end 387 of the hopper 375 to the second end 388 of the hopper 375.

A length axis extends from the rear wall 384 to the front wall 383 of the hopper 375. A lateral axis extends from the first lateral wall 385 to the second lateral wall 386 of the hopper 375. A depth axis extends from the first end 387 of the passage to the second end 388 of the passage. The length, lateral and depth axes are mutually orthogonal. The hopper 375 is longer in the length axis than it is wide in the direction of the lateral axis. The hopper 375 is deeper in the direction of the depth axis than it is wide in the lateral axis. The hopper 375 is deeper in the direction of the depth axis than it is long in the length axis.

At the second end 387 of the hopper 375 is a histology cassette 201 support 389. The histology cassette 201 support 389 has a support surface 890 which is perpendicular to the front wall 383, rear wall 384, first lateral wall 385 and second lateral wall 386 of the hopper 375. The histology cassette 201 support 389 is attached to the rear wall 384 of the hopper 375.

FIGS. 4(a)-(e) shows a method of inserting the stack 250 of histology cassettes 201 (shown in FIG. 2) into the hopper 375 (shown in FIG. 3).

As shown in FIG. 4(a), the stack 250 of histology cassettes 201 has been inserted into (and therefore received by) the hopper 375. The stack 250 of histology cassettes 201 has been inserted into the hopper 375 with the bottom face 228 of the stack 250 of histology cassettes 201 being inserted first into the first open end 387 of the hopper 375. Having been inserted into the hopper 375, the stack 250 of histology cassettes 201 is supported by the support surface 390 of the histology cassette 201 support 389.

The front face 223 of the stack 250 of histology cassettes 201 faces the front wall 383 of the hopper 375, the rear face 224 of the stack 250 of histology cassettes 201 faces the rear wall 384 of the hopper 375, the first lateral face 225 of the stack 250 of the histology cassettes 201 faces the first lateral wall 385 of the hopper 375 and the second lateral face 226 of the stack 250 of the histology cassettes 201 faces the second lateral wall 386 of the hopper 375. The bottom face 228 of the stack 250 of histology cassettes 201 is in contact with the support surface 390 of the histology cassette support 389.

The length of tape 220 that loops round the entire stack 250 of histology cassettes 201 is aligned with the slot 391 in the first lateral face 385 of the hopper 375.

The release region 232 of the length of tape 220 is aligned with the slot 391 in the first lateral wall 385 of the hopper 375. The release region 232 of the length of tape 220 lies parallel to the slot 391 in the first lateral wall 385 of the hopper 375. The release region 232 does not project outwardly from the stack 250 of histology cassettes 201. The first fixing region 230 and the second fixing region 431 of the length of tape 220 are aligned with the slot 391 in the first lateral wall 385 of the hopper 375. The first fixing region 230 and the second fixing region 431 of the length of tape 220 are parallel to the slot 391.

Note that because the tape 220 is aligned with the slot 391, this allows for easy separation of the cassettes 201 within the hopper 375 because the release tab 232 can be pulled by a user after the stack 250 of cassettes 201 has been inserted into the hopper 375. In use, a user pulls on the release region 232 of the tape 220, which causes the first fixing region 230 to begin to detach from the second fixing region 431, as shown in FIG. 4(b).

Next, as the user continues to pull upwardly on the release region 432, the first fixing region 230 becomes completely detached from the second fixing region 431, as shown in FIG. 4(b), and the second end 434 of the length of tape 220 falls out of the hopper 375, as shown in FIG. 4(c).

Next, the user continues to pull on the release region 232 so that the histology cassettes 201 are released in the hopper 375 as shown in FIG. 4(d).

Finally, the tape 220 is removed, leaving behind the released histology cassettes 201 in the hopper 375, as shown in FIG. 4(e).

With the histology cassettes 201 now released, a printer may subsequently take each histology cassette 201 in turn (starting with the first histology cassette 221) in order to print cassette data 108 onto each histology cassette 201 in the hopper 375.

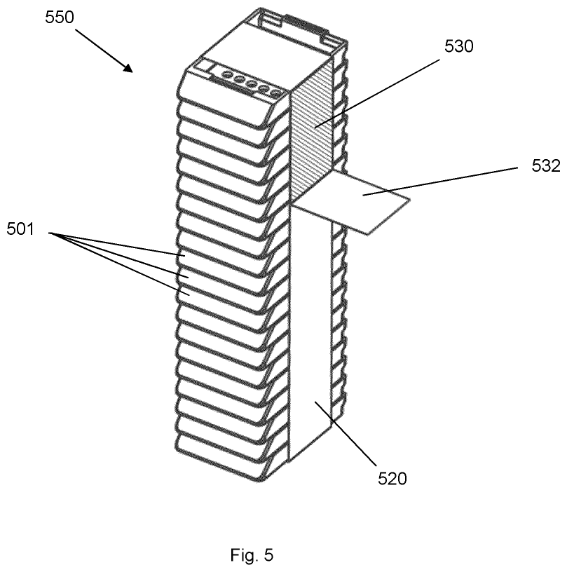

FIG. 5 shows a stack 550 of histology cassettes 501 with a length of tape 520 looped around the entire stack 550 of histology cassettes 501, where the stack 550 of histology cassettes 501 is the same as shown in FIG. 2. In this example the release region 532 projects outwardly from the stack 550 of histology cassettes 501. This helps a user locate the release region 532, prior to pulling on it. In use, a user pulls the release region 532 of the length of tape 520 to remove the length of tape 520 from around the stack 550 of histology cassettes 501.

In some examples (not shown), the length of tape may be looped around the stack of histology cassettes such that it extends along the top, front, bottom and rear faces of the stack.

Alternative, it may be possible for the length of tape looped around the stack of histology cassettes to extend along the front, first lateral, rear and second lateral faces of the stack, depending on the shape of the cassettes, and configuration of the printer.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A stack of histology cassettes configured to be inserted into a hopper of a printer;
wherein each histology cassette in the stack includes a bottom face, a top face opposite the bottom face, a front face, a rear face opposite the front face, a first lateral face and a second lateral face opposite the first lateral face, wherein the top face of the histology cassette is open to allow a sample to be received within the histology cassette;
wherein the histology cassettes have substantially the same orientation within the stack;
wherein the histology cassettes in the stack are arranged with a first histology cassette at the bottom of a stack, and with each subsequent histology cassette in the stack up to a last histology cassette in the stack being arranged with its bottom face being positioned on the top face of a preceding histology cassette in the stack;
wherein the histology cassettes in the stack are held together by a length of tape which loops around the entire stack of histology cassettes;
wherein the length of tape includes a first fixing region and a second fixing region wherein the first fixing region overlaps and adheres to the second fixing region;
wherein the length of tape includes a release region at an end of the length of tape, the release region being configured to be pulled by a user after the stack of histology cassettes has been inserted into a hopper of a printer so as to release the first fixing region from the second fixing region thereby releasing the histology cassettes within the hopper of the printer.

2. The stack of histology cassettes of claim 1 wherein the length of tape holds the histology cassettes rigidly together by applying pressure to the histology cassettes.

3. The stack of histology cassettes of claim 1 wherein the length of tape holds the histology cassettes rigidly together by applying pressure to the histology cassettes without the length of tape adhering to the histology cassettes.

4. The stack of histology cassettes of claim 1 wherein the release region projects outwardly from the stack of histology cassettes.

5. The stack of histology cassettes of claim 1 wherein the length of tape is configured so that the release region projects outwardly from the stack of histology cassettes.

6. The stack of histology cassettes of claim 1, further comprising:
a front face formed by front faces of the cassettes in the stack;
a rear face formed by rear faces of the cassettes in the stack;
a first lateral face formed by first lateral faces of the cassettes in the stack;
a second lateral face formed by second lateral faces of the cassettes in the stack;
a bottom face formed by a bottom face of a first cassette in the stack; and
a top face formed by a top face of a last cassette in the stack;
wherein the length of tape looped around the entire stack of histology cassettes extends along the top face, first lateral face, bottom face and second lateral face of the stack.

7. The stack of histology cassettes of claim 1, wherein the release region is at a first end of the length of tape, wherein the first fixing region is closer to the first end of the length of tape than to a second end of the length of tape opposite to the first end of the length of tape.

8. The stack of histology cassettes of claim 1, wherein the release region and the first fixing region are on the same side of the stack as each other.

9. The stack of histology cassettes of claim 1, wherein the second fixing region is closer to the second end of the length of tape than the first end of the length of tape.

10. A histology cassette system including:
a stack of histology cassettes according to claim 1; and
a printer including a hopper configured to receive the stack of histology cassettes, wherein the printer is configured to print data onto each histology cassette held by the hopper.

11. The histology cassette system of claim 10 wherein the hopper comprises:
a front wall,
a rear wall,
a first lateral wall,
a second lateral wall,
wherein the front wall, the rear wall, the first lateral wall and the second lateral wall define a passage configured to receive the stack of histology cassettes such that when the stack of histology cassettes is inserted into the hopper, the front wall of the stack faces the front wall of the hopper, the rear wall of the stack faces the rear wall of the hopper, the first lateral wall of the stack faces the first lateral wall of the hopper and the second lateral wall of the stack faces the second lateral wall of the hopper.

12. The histology cassette system of claim 10, wherein the first or second lateral wall of the hopper includes a slot extending in the direction of the passage defined by the walls, configured to allow manipulation of the histology cassettes within the hopper,
wherein the tape which loops around the entire stack of histology cassettes is configured such that the release region of the tape is accessible via the slot when the stack of cassettes has been inserted into the hopper.

13. The histology cassette system of claim 12, wherein the release tab is configured to align with the slot when the stack of histology cassettes has been inserted into the hopper.
